(19) United States
(12) Patent Application Publication
(10) Pub. No.: US 2026/0247057 A1
(43) Pub. Date: Aug. 20, 2026

(54) TRIGGERING AN ACTION BASED ON EARCUP ORIENTATION

(71) Applicant: Bose Corporation, Framingham, MA (US)

(72) Inventors: Theodore Bennett, Brookline, NH (US); Sébastien Albouy, Cambridge, MA (US); Benjamin Robert Hart, Brighton, MA (US); John Patrick New, Cambridge, MA (US); Matthew Lamare, Waltham, MA (US); Paul Rathke, Swannanoa, NC (US)

(73) Assignee: Bose Corporation, Framingham, MA (US)

(21) Appl. No.: 19/053,928

(22) Filed: Feb. 14, 2025

(51) Int. Cl. H04R 1/10

(52) U.S. Cl. CPC H04R 1/1041; H04R 1/1008; H04R 1/105; H04R 1/1091; H04R 2420/07

(57) ABSTRACT

A wearable audio device including a first earcup, a second earcup, and a controller. The first earcup includes a first accelerometer configured to generate a first sensor signal. The second earcup includes a second accelerometer configured to generate a second sensor signal. The controller is configured to: (1) generate a first orientation state based on the first sensor signal; (2) generate a second orientation state based on the second sensor signal; and (3) trigger an action in response to each of the first orientation state and the second orientation state meeting an end-of-session orientation condition.

### FIELD OF THE DISCLOSURE

The present disclosure is generally directed to a wearable audio device comprising earcups, and more particularly, to triggering an action by the wearable audio device based on earcup orientation.

### BACKGROUND

A wearable audio device may connect to a source device via a wireless connection. While this wireless connection enables the source device to communicate with the wearable audio device during use, the wireless connection often remains intact when the wearable audio device is no longer in use.

### SUMMARY

The present disclosure is generally directed to systems and methods for providing a wearable audio device (such as audio headphones) with a first earcup, a second earcup, and a controller. The controller monitors an orientation of each of the earcups to determine if a user of the wearable audio device wishes to end their current use session. Based on this determination, the controller triggers one or more actions, such as disconnecting an existing Bluetooth connection or entering a low power mode. These actions create an improved user experience by automatically disconnecting the Bluetooth connection or entering the low power mode when the wearable audio device is not actively being used. For example, automatically disconnecting the Bluetooth connection between the wearable audio device and an external device allows a user to then connect the external device to another device without manually disconnecting the wearable audio device from the external device.

The first earcup includes a first accelerometer generating a first sensor signal, while the second earcup includes a second accelerometer generating a second sensor signal. The controller is communicatively coupled to the first and second accelerometers and receives the first and second sensor signal. The controller generates a first orientation state based on the first sensor signal. The first orientation state represents an orientation of the first earcup. Similarly, the controller generates a second orientation state based on the second sensor signal. The second orientation state represents an orientation of the second earcup. The controller then triggers an action if both the first orientation state and the second orientation state meet an end-of-session orientation condition.

The end-of-session orientation condition may include one or more range-based conditions. For example, the ranges may include a roll range and a pitch range. Similarly, the orientation states may be defined in terms of a roll angle and a pitch angle. Thus, in some examples, if, for each earcup, (1) the roll angle is within the roll range and (2) the pitch angle is within the pitch range, then the end-of-session orientation condition is met. In some examples, the roll range corresponds to the first earcup being rotated into a parallel position with the second earcup. Similarly, the pitch range may correspond to the first and second earcup being oriented perpendicular to gravity. Thus, the range-based conditions may be met if the user removes the wearable audio device from their head and arranges the device flat on a table or other surface with both earcups facing downward, indicating the user has ended their listening session. In some examples, only one of the range-based conditions may need to be met to meet the end-of-session orientation condition.

In some examples, the action may include disconnecting an existing Bluetooth connection. For example, the controller may include a transceiver to facilitate a Bluetooth connection with an external device. The Bluetooth connection may be active prior to the triggering of the action. Once the action is triggered, the controller instructs the transceiver to disconnect from the external device. Further, the controller may gather additional sensor signals from the accelerometers to determine if an active session condition is met. The active session condition may correspond to earcups being arranged in a manner indicative that the user wishes to resume use. Thus, if the active session condition is met, the Bluetooth connection may be restored without requiring additional input from the user.

In some examples, the action may include triggering the controller to enter a low power mode. In the low power mode, certain functionality of the wearable audio device may be reduced or suspended. The low power mode may be triggered after a predetermined period of time after determining that the end-of-session orientation condition has been met. In further examples, the controller may exit a low power mode based on an on-head detection signal generated by an on-head sensor of the wearable audio device. If on-head detection signal indicates that the wearable audio device is being worn, the controller may exit low power mode.

Generally, in one aspect, a wearable audio device is provided. The wearable audio device includes a first earcup. The first earcup includes a first accelerometer. The first accelerometer is configured to generate a first sensor signal.

The wearable audio device further includes a second earcup. The second earcup includes a second accelerometer. The second accelerometer is configured to generate a second sensor signal.

The wearable audio device further includes a controller. The controller is configured to generate a first orientation state based on the first sensor signal at a first point in time. The controller is further configured to generate a second orientation state based on the second sensor signal at the first point in time. The controller is further configured to trigger an action in response to each of the first orientation state and the second orientation state meeting an end-of-session orientation condition.

According to an example, a transceiver of the wearable audio device is wirelessly connected to an external device via a Bluetooth connection. The action includes disconnecting the Bluetooth connection.

According to an example, the controller is further configured to: (1) updating the first orientation state based on the first sensor signal at a second point in time; (2) updating the second orientation state based on the second sensor signal at the second point in time; and (3) reconnect the Bluetooth connection in response to at least one of the updating first orientation state and the updated second orientation state meeting an active session orientation condition.

According to an example, the end-of-session orientation condition comprises a roll range. The first orientation state includes a first roll angle. The second orientation state includes a second roll angle. The end-of-session orientation condition is met in response to each of the first roll angle and the second roll angle being within the roll range.

According to an example, the end-of-session orientation condition includes a pitch range. The first orientation state includes a first pitch angle. The second orientation state includes a second pitch angle. The end-of-session orientation condition is met in response to each of the first pitch angle and the second pitch angle being within the pitch range.

According to an example, the first earcup or the second earcup includes the controller.

According to an example, the first earcup is coupled to the second earcup via a headband.

According to an example, the action comprises triggering the controller to enter a low power mode.

According to an example, the controller enters the low power mode after a predetermined period after determining that the first orientation state and the second orientation state meet the end-of-session orientation condition.

According to an example, the controller is further configured to: (1) receive an on-head detection signal generated by an on-head sensor; and (2) exit the low power mode based on the on-head detection signal.

Generally, in another aspect, a method for triggering an action of a wearable audio device is provided. The method includes: (1) generating, via a controller of the wearable audio device, a first orientation state based on a first sensor signal at a first point in time, wherein the first sensor signal is generated by a first accelerometer arranged within a first earcup of the wearable audio device; (2) generating, via the controller, a second orientation state based on a second sensor signal at the first point in time, wherein a second sensor signal is generated by a second accelerometer arranged within a second earcup of the wearable audio device; and (3) triggering, via the controller, an action in response to each of the first orientation state and the second orientation state meeting an end-of-session orientation condition.

According to an example, a transceiver of the wearable audio device is wirelessly connected to an external device via a Bluetooth connection. The action comprises disconnecting the Bluetooth connection.

According to an example, the method further includes: (1) updating the first orientation state based on the first sensor signal at a second point in time; (2) updating the second orientation state based on the second sensor signal at the second point in time; and (3) reconnecting the Bluetooth connection in response to at least one of the updated first orientation state and the updated second orientation state meeting an active session orientation condition.

According to an example, the end-of-session orientation condition comprises a roll range. The first orientation state includes a first roll angle. The second orientation state includes a second roll angle. The end-of-session orientation condition is met in response to each of the first roll angle and the second roll angle being within the roll range.

According to an example, the end-of-session orientation condition includes a pitch range. The first orientation state includes a first pitch angle. The second orientation state includes a second pitch angle. The end-of-session orientation condition is met in response to each of the first pitch angle and the second pitch angle being within the pitch range.

According to an example, the first earcup or the second earcup comprises the controller.

According to an example, the first earcup is coupled to the second earcup via a headband.

According to an example, the action comprises triggering the controller to enter a low power mode.

According to an example, the controller enters the low power mode after a predetermined period after determining that the first orientation state and the second orientation state meet the end-of-session orientation condition.

According to an example, the method further includes: (1) receiving, via the controller, an on-head detection signal generated by an on-head sensor; and (2) exiting, via the controller, the low power mode based on the on-head detection signal.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an isometric view of a wearable audio device, in accordance with an example.

FIG. 2 is a front view of a wearable audio device, in accordance with an example.

FIG. 3 is a functional block diagram of aspects of a wearable audio device, in accordance with an example.

FIG. 4 is a side view of a wearable audio device worn by a user, in accordance with an example.

FIG. 5 is a side view of a wearable audio device positioned flat on a surface, in accordance with an example.

FIG. 6 is a bottom view of a wearable audio device positioned flat on a surface, in accordance with an example.

FIG. 7 is a further bottom view of a wearable audio device positioned flat on a surface, in accordance with an example.

FIG. 8 is a functional block diagram of aspects of a controller of a wearable audio device, in accordance with an example.

FIG. 9 is a flow chart of a method for triggering an action of a wearable audio device, in accordance with an example.

FIG. 10 is a further flow chart of aspects of a method for triggering an action of a wearable audio device, in accordance with an example.

### DETAILED DESCRIPTION

The present disclosure is generally directed to systems and methods for providing a wearable audio device with a first earcup, a second earcup, and a controller. The controller monitors the orientation of the earcups to determine if a user of the wearable audio device wishes to end their current use session. Based on this determination, the controller triggers one or more actions, such as disconnecting an existing Bluetooth connection or entering a low power mode. These actions create an improved user experience by automatically disconnecting the Bluetooth connection or entering the low power mode when the wearable audio device is not actively being used. The first earcup includes a first accelerometer generating a first sensor signal, while the second earcup includes a second accelerometer generating a second sensor signal. The controller is communicatively coupled to the first and second accelerometers and receives the first and second sensor signal. The controller generates a first orientation state based on the first sensor signal. The first orientation state represents an orientation of the first earcup. Similarly, the controller generates a second orientation state based on the second sensor signal. The second orientation state represents an orientation of the second earcup. The controller then triggers an action if both the first orientation state and the second orientation state meet an end-of-session orientation condition.

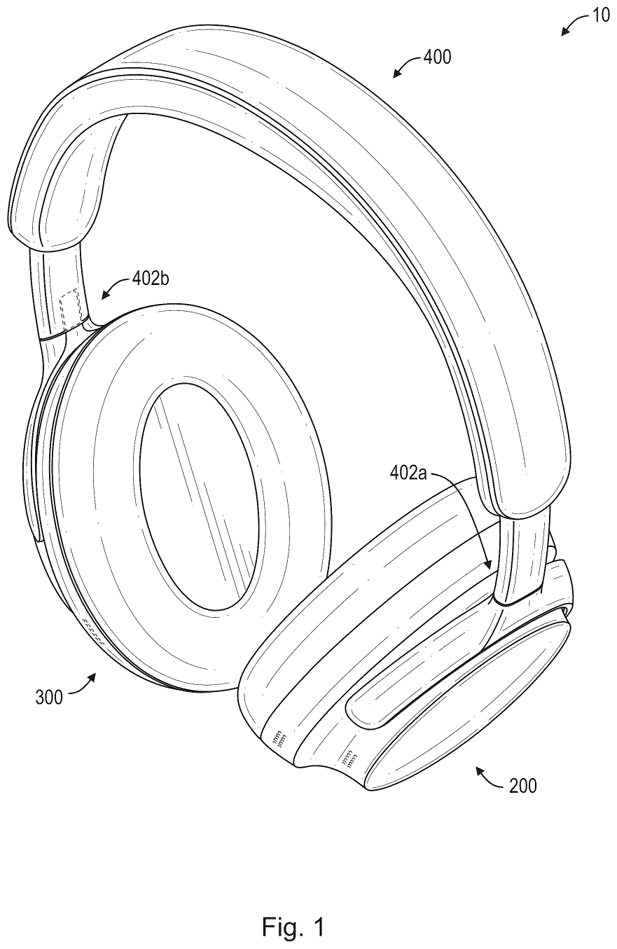

The following description should be read in view of FIGS. 1-10.

The term “wearable audio device,” as used in this application, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the earcup or headphone. A wearable audio device can include components for wirelessly receiving audio signals. A wearable audio device can include components of an active noise reduction (ANR) system. Wearable audio devices can also include other components such as a microphone so that they can function as a headset. While the non-limiting example of FIG. 1 depicts the wearable audio device 10 as audio headphones with a pair of earcups, the wearable audio device 10 described below may be any of the aforementioned types of devices.

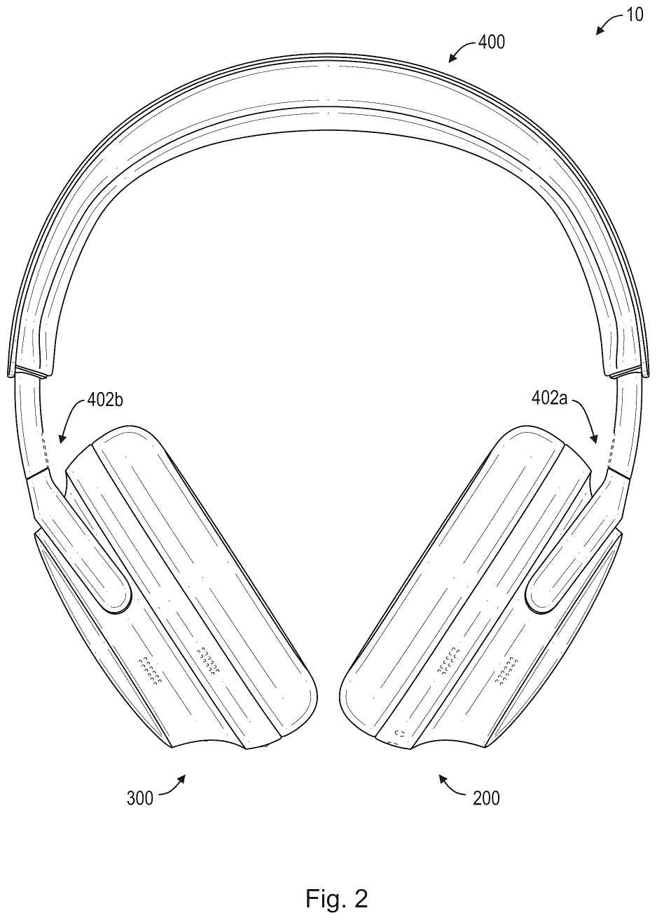

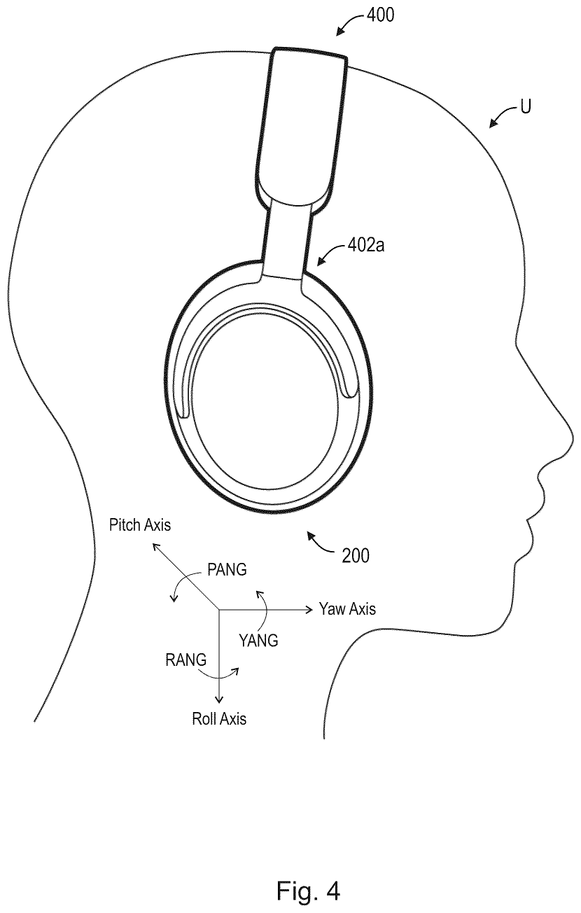

FIGS. 1 and 2 illustrate a wearable audio device 10 embodied as audio headphones. In the non-limiting examples of FIGS. 1 and 2, the wearable audio device 10 includes a first earcup 200, a second earcup 300, and a headband 400. The first earcup 200 is coupled to the headband 400 via a first hinge 402a. The first hinge 402a enables the first earcup 200 to fold inwards towards the headband 400. Further, the first hinge 402a enables the first earcup 200 to rotate about the hinge 402a. Similarly, the second earcup 300 is coupled to the headband 400 via a second hinge 402b. The second hinge 402b enables the second earcup 300 to fold inwards towards the headband 400. Further, the second hinge 402b enables the second earcup 300 to rotate about the hinge 402b. The folding and rotation of the earcups 200, 300 will be described in greater detail with reference to FIGS. 4-7.

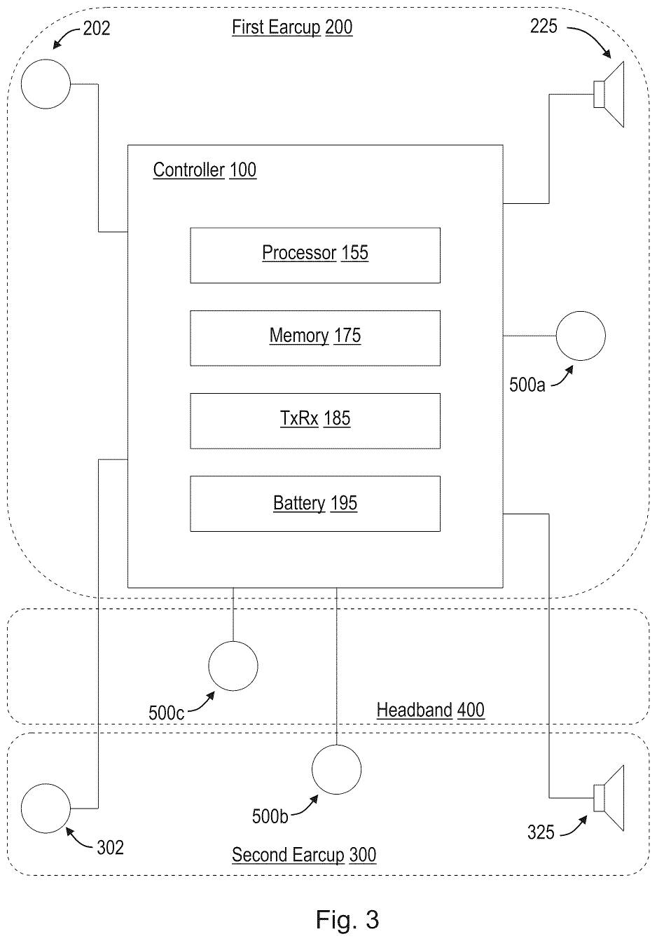

FIG. 3 is a functional block diagram of various electronic and electro-mechanical aspects of the wearable audio device 10. As shown in FIG. 3, the wearable audio device 10 includes a controller 100, a first accelerometer 202, a first acoustic transducer 225, a second accelerometer 302, a second acoustic transducer 325, and one or more on-head sensors 500a-500c. The non-limiting example of the controller 100 includes a processor 155, a memory 175, a transceiver 185, and a battery 195. Generally, the processor 155 is configured to receive and process electronic signals retrieved from memory 175 and/or provided by the first accelerometer 202, the second accelerometer 302, and the on-head sensors 500a-500c, while also providing electronic signals to the first acoustic transducer 225 and the second acoustic transducer 325 to render audio for a user to hear. The memory 175 may be used to store data related to the electronic signals processed or generated by the processor 155. The transceiver 185 may be used to wirelessly transmit and/or receive data to one or more external devices, such as a smartphone, personal computer, speaker, etc. The battery 195 may be used to power aspects of the controller 100 and/or other active aspects of the wearable audio device 10. In some examples, the on-head sensor may be a capacitive sensor configured to detect the presence of a head of the user. In other examples, the on-head sensor may be an optical sensor. In further examples, the on-head sensor may be a combination of two or more sensors. The two or more sensors may be of the same or different type.

In the non-limiting example of FIG. 3, the controller 100, the first accelerometer 202, and the first acoustic transducer 225 are arranged within the first earcup 200, and the second accelerometer 302 and the second acoustic transducer 325 are arranged within the second earcup 300. Thus, the second accelerometer 302 and the second acoustic transducer 325 may be electrically coupled to the controller 100 via two or more wires travelling from the second earcup 300 to the first earcup 200 via the headband 400.

As shown in FIG. 3, the wearable audio device 10 may include one or more on-head sensors 500a-500c. In one example, an on-head sensor 500a may be arranged within the first earcup 200. In another example, an on-head sensor 500b may be arranged within the second earcup 300. In a further example, an on-head sensor 500c may be arranged within the headband 400. In an even further example, the wearable audio device 10 may include both a first on-head sensor 500a within the first earcup 200 and a second on-head sensor 500b within the second earcup 300. If an on-head sensor 500c is arranged within the headband 400, the on-head sensor 500c may be electrically connected to the controller 100 via one or more wires travelling from the headband 400 to the first earcup 200. Similarly, if an on-head sensor 500b is arranged within the second earcup 300, the on-head sensor 500b may be electrically connected to the controller 100 via one or more wires travelling from the second earcup 300 to the first earcup 200 via the headband 400. In other examples, the controller 100 may be arranged in other aspects of the wearable audio device 10, such as within the second earcup 300. Further, the wearable audio device 10 may contain additional components, such as one or more microphones for voice pickup and/or noise reduction purposes.

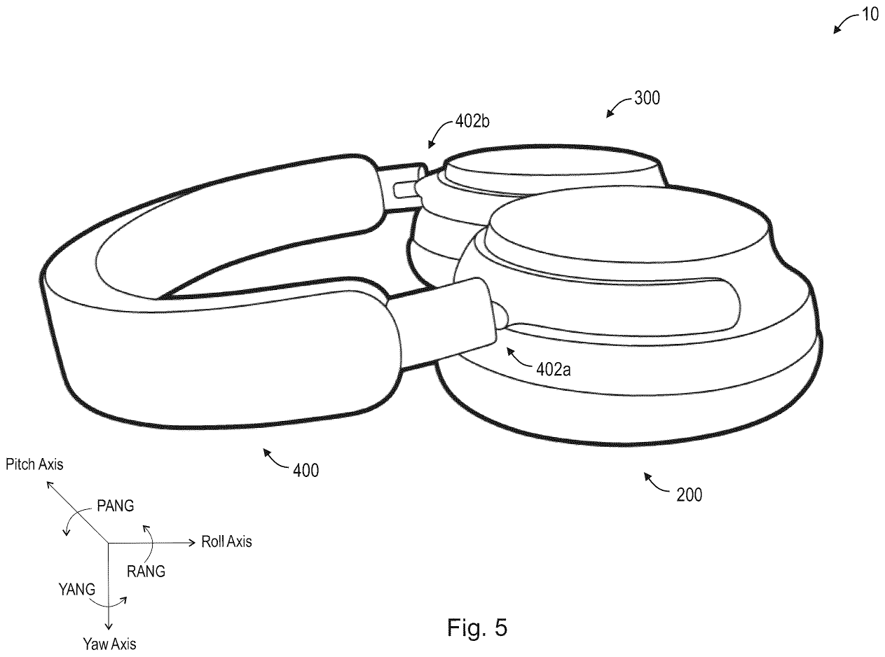

FIG. 4 shows a side view of the wearable audio device 10 arranged on a user U. In particular, FIG. 4 shows the first earcup 200 coupled to the headband 400 via the first hinge 402a. Further, an orientation of the first earcup 200 may be defined in terms of a roll angle RANG about a roll axis, a pitch angle PANG about a pitch axis, and a yaw angle YANG about a yaw axis. Generally, and as will be shown in more detail in FIGS. 5-7, the yaw angle YANG defines the degree of folding of the first earcup 200 about the first hinge 402a toward the headband. The second earcup 300 (not shown in FIG. 4) may have a different yaw angle YANG than the first earcup 200. The pitch angle PANG defines the forward or backward tilt of the first earcup 200. In most cases, neither the first earcup 200 nor the second earcup 300 may rotate around the pitch axis independently. Accordingly, the first earcup 200 and the second earcup 300 will be defined by the same pitch angle PANG. The roll angle RANG defines the rotation of the first earcup 200 about the hinge 402a. The second earcup 300 may have a different roll angle than the second earcup 300.

As will be demonstrated, analyzing the orientation of each of the earcups 200, 300 of the wearable audio device 10 enables the controller 100 to determine if the user has ended their current listening session. By determining that the session has ended, the controller 100 may take one or more actions. These actions may relate to conserving battery life, such as by disabling a wireless connection (such as a Bluetooth connection) or causing the controller 100 to enter a low power mode (also referred to as sleep mode or hibernation mode). Further, it is important to distinguish a user temporarily removing the wearable audio device 10 from their head for a short period of time from the user wishing to end their current listening session. Indeed, a user may be annoyed or irritated by the wearable audio device 10 disconnecting from a wireless connection or entering a low power mode every time the wearable audio device 10 is removed from their head.

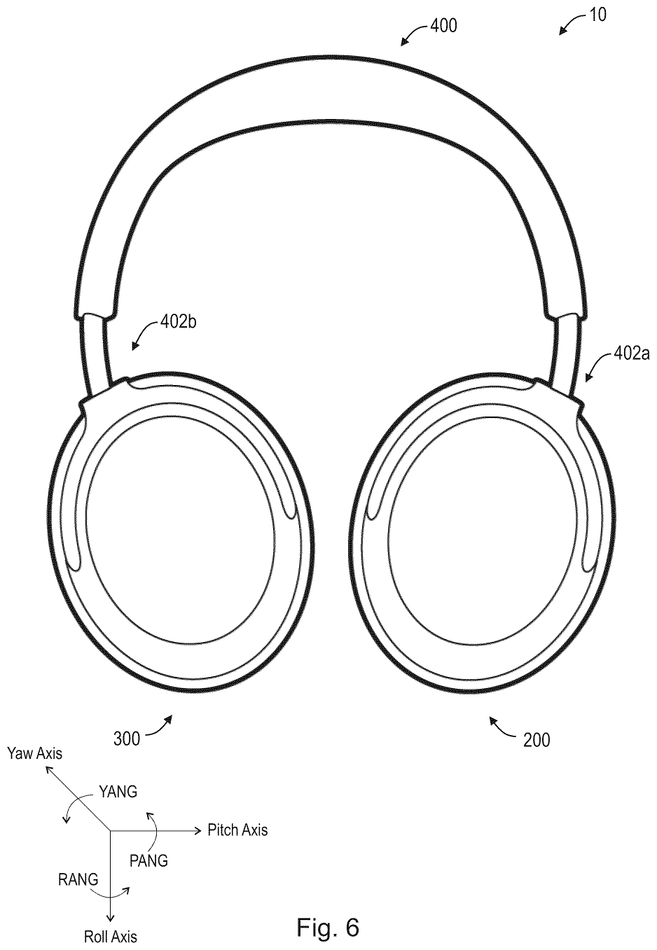

FIG. 5 illustrates a further side view of the wearable audio device 10 in an orientation indicative of a user wishing to end their current listening session. Further, the orientation of the first earcup 200 as shown in FIG. 4 may be considered to be a default orientation. Thus, the roll angle RANG, and the pitch angle PANG, and the yaw angle YANG may be considered to be approximately 0 degrees. In this default orientation, the wearable audio device 10 lays flat on a horizontal surface, such as a table. To facilitate this orientation, both the first earcup 200 and the second earcup 300 are orientated according to a roll angle RANG of approximately 0 degrees such that the first and second earcups 200, 300 are arranged approximately in a parallel position. Similarly, both the first earcup 200 and the second earcup 300 have tilted according to a pitch angle PANG of approximately 0 degrees such that the first and second earcups 200, 300 are oriented approximately perpendicular to gravity. A bottom view of this orientation is shown in FIG. 6. In some examples, the wearable audio device 10 may interpret an end-of-session if both the roll angle RANG and the pitch angle PANG are within +15 degrees and −15 degrees.

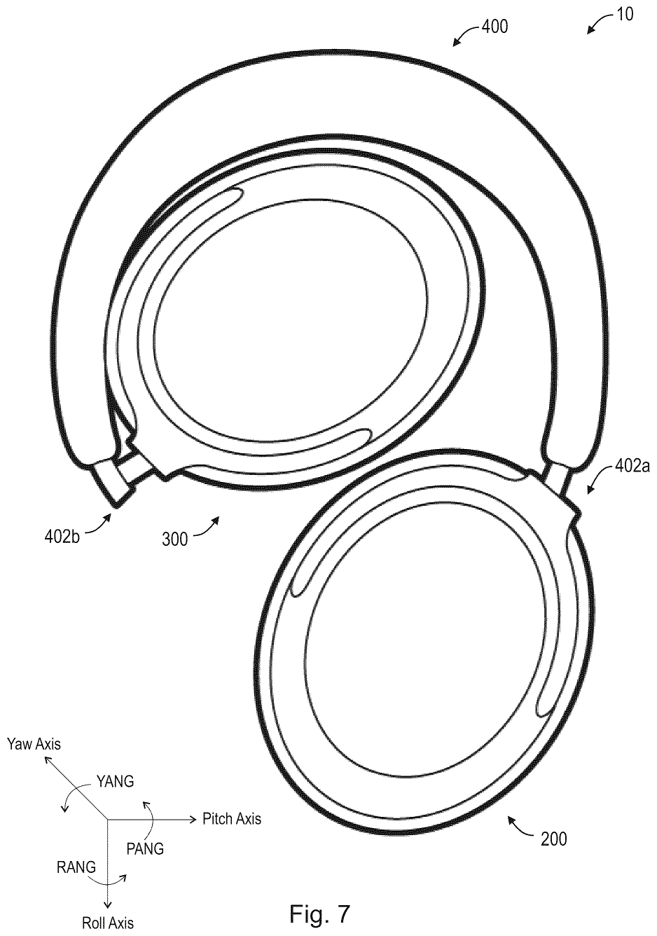

In the examples of FIGS. 5 and 6, the end-of-session may be indicated regardless of yaw angle YANG of the first earcup 200 or the second earcup 300. As shown in FIGS. 5 and 6, the first and second earcup 200, 300 are both in an unfolded position, and therefore have a yaw angle YANG of approximately 0 degrees. In FIG. 7, the first earcup 200 is in a folded position, and therefore has a yaw angle YANG of approximately 135 degrees, while the second earcup 300 is in the unfolded position and maintains a yaw angle YANG of approximately 0 degrees.

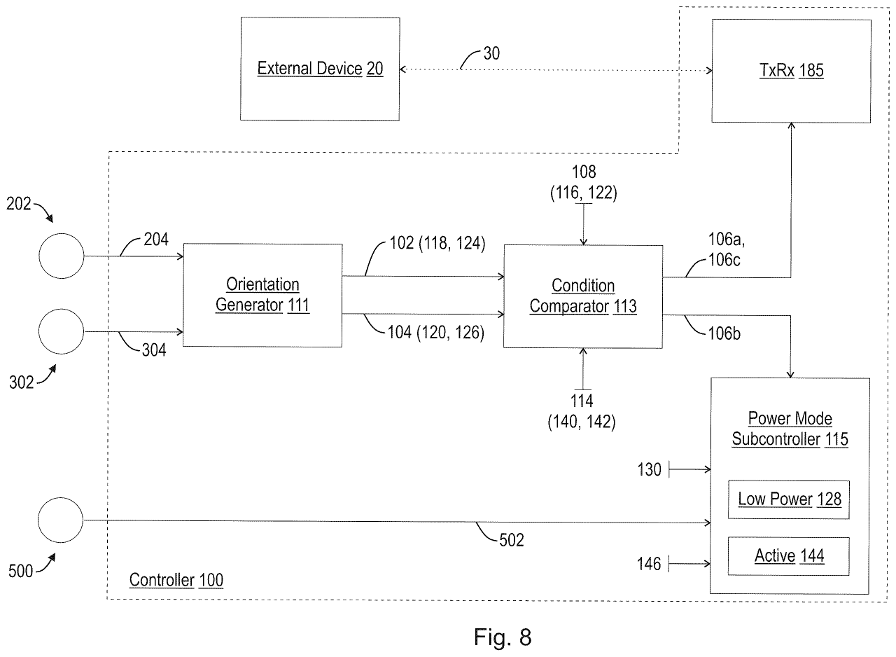

FIG. 8 is a functional block diagram of aspects of the controller 100 of the wearable audio device 10. In particular, the controller 100 is configured to determine if the wearable audio device 10 is oriented as shown in FIGS. 5 and 6 (indicating that the user wishes to end their current listening session) and trigger a corresponding action (such as disconnecting from a wireless connection and/or entering a low power mode). As shown in FIG. 8, the aspects of the controller 100 may be executed by the processor 155 shown in FIG. 3. Further, the signals and/or data received, processed, and/or generated by the controller 100 may be stored in the memory 175 shown in FIG. 3.

As shown in FIG. 8, the first accelerometer 202 (arranged in the first earcup 200) provides a first sensor signal 204 to the orientation generator 111. Further, the second accelerometer 302 (arranged in the second earcup 300) provides a second sensor signal 304 to the orientation generator 111. The first and second sensor signals 204, 304 may be vectors defining the acceleration of the first earcup 200 and the second earcup 300, respectively.

The orientation generator 111 generates a first orientation state 102 based on the first sensor signal 204 at a first point in time. Thus, the first orientation state 102 defines the orientation of the first earcup 200. The first orientation state 102 may be defined in terms of a first roll angle 118 and a first pitch angle 124. Further, the orientation generator 111 also generates a second orientation state 104 based on the second sensor signal 204 at the first point in time. Thus, the second orientation state 104 defines the orientation of the second earcup 300. The second orientation state 104 may be defined in terms of a second roll angle 120 and a second pitch angle 126. As described with respect to FIGS. 4-7, the roll angle 118 and the pitch angle 124 of the first earcup 200 and the roll angle 120 and the pitch angle 126 of the second earcup 300 may be used to determine if the user wishes to end their listening session.

The first orientation state 102 and the second orientation state 104 are then provided to a condition comparator 113. The condition comparator 113 is configured to analyze the first and second orientation state 102, 104 and trigger an action if an end-of-session orientation condition 108 is met. As shown in FIG. 8, the end-of-session orientation condition 108 is defined by a roll range 116 and a pitch range 122. Accordingly, for the end-of-session orientation condition 108 to be met, (1) the first and second roll angles 118, 120 (corresponding to the first and second earcups 200, 300) must be within the roll range 116 and (2) the first and second pitch angles 124, 126 (also corresponding to the first and second earcups 200, 300) must be within the pitch range 122. In some non-limiting examples, to correspond to the arrangement where the wearable audio device 10 is oriented flat on a surface as shown in FIGS. 5 and 6, the roll range 116 is from −15 degrees to +15 degrees, and the pitch range 122 is from −15 degrees to +15 degrees. In some examples, rather than compare both of the first and second roll angles 118, 120 to a single roll range 116, the first roll angle 118 may be compared to a first roll range 116a, while the second roll angle 120 may be compared to a second roll range 116b, wherein the first roll range 116a is different than the second roll range 116b.

If the end-of-session orientation condition is met, one or more action signals 106 may be generated. In some examples, a disconnect signal 106a is generated by the condition comparator 113. As shown in FIG. 8, the disconnect signal 106a is provided to the transceiver 185. As shown in FIG. 8, the transceiver 185 facilitates a wireless connection 30, such as a Bluetooth connection, with an external device 20. In some examples, the external device 20 is a smartphone, personal computer, speaker, etc., configured to stream audio content to the wearable audio device 10 to be rendered by the acoustic transducers 225, 325. Accordingly, to conserve power stored in the battery 195 when the user wishes to end their listening session, the disconnect signal 106a triggers the transceiver 185 to end the connection between the transceiver 185 and the external device 20. Automatically disconnecting the transceiver 185 from the external device 20 in this way also creates an improved user experience by allowing a user to then connect the external device 20 to another device without first manually disconnecting the wearable audio device 10 from the external device 20.

In other examples, the condition comparator 113 may generate a low power signal 106b. The low power signal 106b is then provided to a power mode subcontroller 115. The power mode subcontroller 115 may configure the controller 100 to operate in either low power mode 128 or active mode 144. In low power mode 128, certain functionality or features enabled in active mode 144 may be reduced and/or disabled. Thus, the low power signal 106b triggers the power mode subcontroller 115 to configure the controller 100 to switch from active mode 144 to low power mode 128. In some examples, this switch may occur only after a predetermined period 130 after the power mode subcontroller 115 receives the low power signal 106b, such as one second or more.

In further examples, after the wearable audio device 10 has been oriented flat on a surface to end a listening session, the user may wish to start a new listening session and wirelessly reconnect the wearable audio device 10 to the external device 20. As shown in FIG. 8, the first accelerometer 202 continues to provide the first sensor signal 204 to the orientation generator 111. Further, the second accelerometer 302 continues to provide the second sensor signal 304 to the orientation generator 111. The orientation generator 111 then updates the first orientation state 102 based on the first sensor signal 204 at a second point in time. The second point in time is subsequent to the first point in time. Thus, the updated first orientation state 102 defines the new orientation of the first earcup 200. The updated first orientation state 102 may be defined in terms of an updated first roll angle 118 and an updated first pitch angle 124. Further, the orientation generator 111 also updates the second orientation state 104 based on the second sensor signal 304 at the second point in time. Thus, the updated orientation state 104 defines the orientation of the second earcup 300. The updated second orientation state 104 may be defined in terms of an updated second roll angle 120 and an updated second pitch angle 126.

The updated first orientation state 102 and the updated second orientation state 104 are then provided to the condition comparator 113. The condition comparator 113 is configured to analyze the updated first and second orientation states 102, 104 and trigger an action if an active session orientation condition 114 is met. As shown in FIG. 8, and like the end-of-session orientation condition 108, the active session orientation condition may also be defined by a roll range 140 and a pitch range 142. In some examples, the roll range 140 and the pitch range 142 of the active session orientation condition 114 may match the roll range 116 and the pitch range 122 of the end-of-session orientation condition 108. In this example, for the active session orientation condition 114 to be met, at least one of the following must occur: (1) the updated first roll angle 118 is outside of the roll range 140; (2) the updated second roll angle 124 outside of the roll range 140; (3) the updated first pitch angle 120 is outside of the pitch range 142; or (4) the updated second pitch angle 126 is outside of the pitch range 142. As shown in FIGS. 5-7, the updated first and second roll angles 118, 124 may be different, as the first and second earcups 200, 300 or individually rotatable about the roll axis. However, in most embodiments, the updated first pitch angle 120 and the updated second pitch angle 126 should be equal, as the entire wearable audio device 10 must be tilted to rotate the first and second earcups 200, 300 about the pitch axis. If the active session orientation condition 114 is met, the condition comparator 113 generates a reconnect signal 106c. The reconnect signal 106c is provided to the transceiver 185 to trigger a wireless connection 30 (such as a Bluetooth connection) to be formed between the transceiver 185 and the external device 20.

Further, in some examples, the on-head sensor 500 may be used to trigger the controller 100 to revert back into the active mode 144 from the low power mode 128. As previously described, the low power mode 128 may be triggered by determining that the user has removed the wearable audio device 10 from their head and arranged the wearable audio device 10 flat on a surface as illustrated in FIGS. 5 and 6. As shown in FIG. 8, the on-head sensor 500 generates an on-head detection signal 502. The on-head detection signal 502 fluctuates based on the proximity of the on-head sensor 500 to the head of the user. The on-head detection signal 502 is then provided to the power mode subcontroller 115. If the on-head detection signal 502 exceeds a detection threshold 146, the power mode subcontroller 115 enters active mode 144.

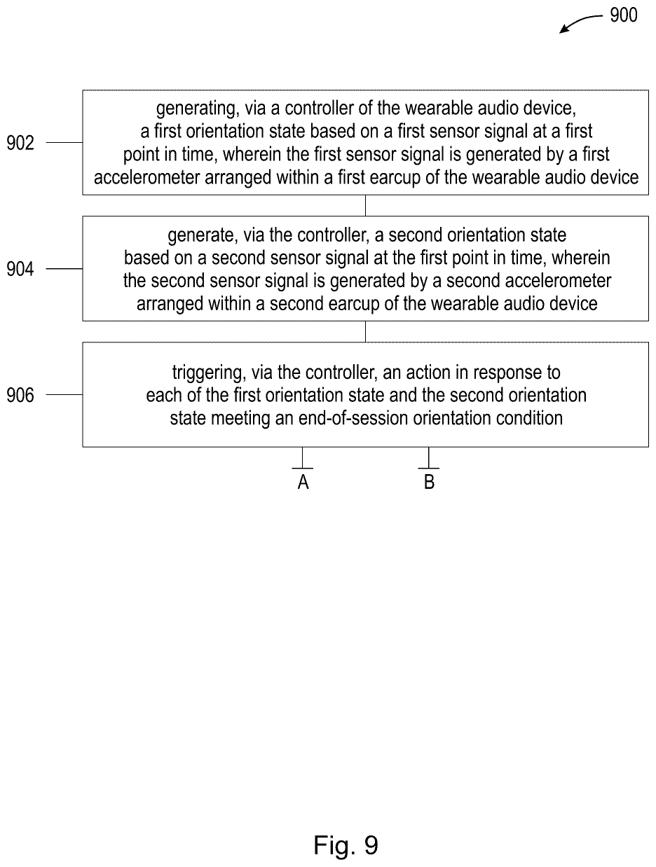

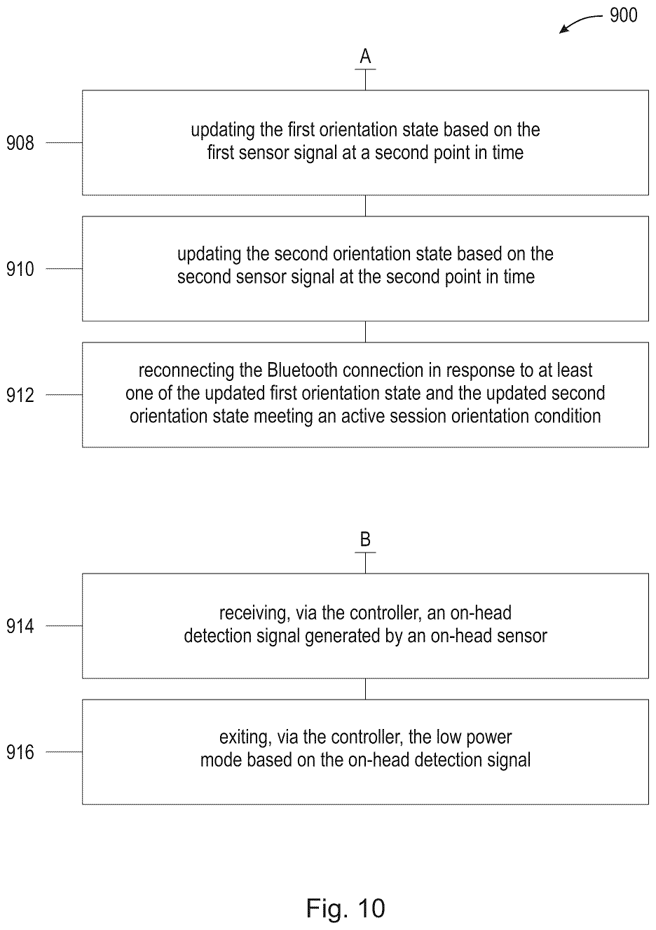

FIGS. 9 and 10 are flow charts of a method 900 for triggering an action of a wearable audio device 10. The method 900 includes, in step 902, generating, via a controller 100 of the wearable audio device 10, a first orientation state 102 based on a first sensor signal 204, wherein the first sensor signal 204 is generated by a first accelerometer 202 arranged within a first earcup 200 of the wearable audio device 10.

The method 900 further includes, in step 904, generating, via the controller 100, a second orientation state 104 based on a second sensor signal 304. The second sensor signal 304 is generated by a second accelerometer 302 arranged within a second earcup 300 of the wearable audio device 10.

The method 900 further includes, in step 906, triggering, via the controller 100, an action in response to each of the first orientation state 102 and the second orientation state 104 meeting an end-of-session orientation condition 108. As described above, the action may relate to disconnecting a Bluetooth connection between the wearable audio device 10 and an external device 20 or triggering the controller 100 to enter a low power mode 128.

Further, in some examples, the method 900 may include, in optional step 908, generating an updated first orientation state 102 based on the first sensor signal 204 at a second point in time. The method 900 may further include, in optional step 910, generating an updated second orientation state 104 based on the second sensor signal 304 at the second point in time. The method 900 may further include, in optional step 912, reconnecting the Bluetooth connection in response to at least one of the updated first orientation state 102 and the updated second orientation state 104 meeting an active session orientation condition 114.

Additionally, in further examples, the method 900 may include, in optional step 914, receiving, via the controller 100, an on-head detection signal 502 generated by an on-head sensor 500. The method 900 may further include, in optional step 914, exiting, via the controller 100, the low power mode 128 based on the on-head detection signal 502.

All definitions, as defined and used herein, should be understood to control over dictionary definitions and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A wearable audio device comprising:
a first earcup comprising a first accelerometer, wherein the first accelerometer is configured to generate a first sensor signal;
a second earcup comprising a second accelerometer, wherein the second accelerometer is configured to generate a second sensor signal; and
a controller configured to:
generate a first orientation state based on the first sensor signal at a first point in time;
generate a second orientation state based on the second sensor signal at the first point in time; and
trigger an action in response to each of the first orientation state and the second orientation state meeting an end-of-session orientation condition.

2. The wearable audio device of claim 1, wherein a transceiver of the wearable audio device is wirelessly connected to an external device via a Bluetooth connection, and wherein the action comprises disconnecting the Bluetooth connection.

3. The wearable audio device of claim 2, wherein the controller is further configured to:
update the first orientation state based on the first sensor signal at a second point in time;
update the second orientation state based on the second sensor signal at the second point in time; and
reconnect the Bluetooth connection in response to at least one of the updated first orientation state and the updated second state meeting an active session orientation condition.

4. The wearable audio device of claim 1, wherein the end-of-session orientation condition comprises a roll range, wherein the first orientation state includes a first roll angle, wherein the second orientation state includes a second roll angle, wherein the end-of-session orientation condition is met in response to each of the first roll angle and the second roll angle being within the roll range.

5. The wearable audio device of claim 1, wherein the end-of-session orientation condition comprises a pitch range, wherein the first orientation state includes a first pitch angle, wherein the second orientation state includes a second pitch angle, wherein the end-of-session orientation condition is met in response to each of the first pitch angle and the second pitch angle being within the pitch range.

6. The wearable audio device of claim 1, wherein the first earcup or the second earcup comprises the controller.

7. The wearable audio device of claim 1, wherein the first earcup is coupled to the second earcup via a headband.

8. The wearable audio device of claim 1, wherein the action comprises triggering the controller to enter a low power mode.

9. The wearable audio device of claim 8, wherein the controller enters the low power mode after a predetermined period after determining that the first orientation state and the second orientation state meet the end-of-session orientation condition.

10. The wearable audio device of claim 8, wherein the controller is further configured to:
receive an on-head detection signal generated by an on-head sensor; and
exit the low power mode based on the on-head detection signal.

11. A method for triggering an action of a wearable audio device, comprising:
generating, via a controller of the wearable audio device, a first orientation state based on a first sensor signal at a first point in time, wherein the first sensor signal is generated by a first accelerometer arranged within a first earcup of the wearable audio device;
generating, via the controller, a second orientation state based on a second sensor signal at the first point in time, wherein the second sensor signal is generated by a second accelerometer arranged within a second earcup of the wearable audio device; and
triggering, via the controller, an action in response to each of the first orientation state and the second orientation state meeting an end-of-session orientation condition.

12. The method of claim 11, wherein a transceiver of the wearable audio device is wirelessly connected to an external device via a Bluetooth connection, and wherein the action comprises disconnecting the Bluetooth connection.

13. The method claim 12, further comprising:
updating the first orientation state based on the first sensor signal at a second point in time;
updating the second orientation state based on the second sensor signal at the second point in time; and
reconnecting the Bluetooth connection in response to at least one of the updated first orientation state and the updated second orientation state meeting an active session orientation condition.

14. The method of claim 11, wherein the end-of-session orientation condition comprises a roll range, wherein the first orientation state includes a first roll angle, wherein the second orientation state includes a second roll angle, wherein the end-of-session orientation condition is met in response to each of the first roll angle and the second roll angle being within the roll range.

15. The method of claim 11, wherein the end-of-session orientation condition comprises a pitch range, wherein the first orientation state includes a first pitch angle, wherein the second orientation state includes a second pitch angle, wherein the end-of-session orientation condition is met in response to each of the first pitch angle and the second pitch angle being within the pitch range.

16. The method of claim 11, wherein the first earcup or the second earcup comprises the controller.

17. The method of claim 11, wherein the first earcup is coupled to the second earcup via a headband.

18. The method of claim 11, wherein the action comprises triggering the controller to enter a low power mode.

19. The method of claim 18, wherein the controller enters the low power mode after a predetermined period after determining that the first orientation state and the second orientation state meeting the end-of-session orientation condition.

20. The method of claim 18, further comprising:
receiving, via the controller, an on-head detection signal generated by an on-head sensor; and
exiting, via the controller, the low power mode based on the on-head detection signal.
